(19) United States
(12) Patent Application Publication
(10) Pub. No.: US 2022/0163368 A1
(43) Pub. Date: May 26, 2022

(54) Angle Detection Device

(71) Applicant: Vitesco Technologies GmbH, Hannover (DE)

(72) Inventor: Werner WALLRAFEN, Munich (DE)

(21) Appl. No.: 17/439,950

(22) PCT Filed: Mar. 19, 2020
(86) PCT No.: PCT/EP2020/057664

§ 371 Date: Sep. 16, 2021

(30) Foreign Application Priority Data
Mar. 20, 2019 (DE) 10 2019 203 825.5
Mar. 20, 2019 (DE) 10 2019 203 827.1

(51) Int. Cl. G01F 23/263; G01F 23/38; G01F 23/80

(52) U.S. Cl. CPC G01F 23/265; G01F 23/266; G01F 23/802; G01F 23/38

(57) ABSTRACT

An angle detection device for a fuel fill level detection device, including: a support, a potting composition, which is arranged on the support in coherently bonded manner; a sensor for the contactless detection of an orientation of a magnetic field of a magnet, which is at least partly arranged in the potting composition, in particular on the support, and at least one conductor track which is arranged flat on the support, in particular in coherently bonded manner.

### CROSS REFERENCE TO RELATED APPLICATIONS

This is a U.S. national stage of Application No. PCT/EP2020/057664 filed Mar. 19, 2020. Priority is claimed on German Application Nos. DE 10 2019 203 825.5 and DE 10 2019 203 827.1 filed Mar. 20, 2019 the content of which is incorporated herein by reference.

### BACKGROUND OF THE INVENTION

### 1. Field of the Invention

The present disclosure relates to an angle detection device, an angle detection arrangement, and a fuel fill level detection device with the angle detection device, and also to methods for the detection of an angle by the angle detection device, in particular angle detection arrangement, for the detection of a fuel fill level by the fuel fill level detection device, and also for the production of the angle detection device.

### 2. Description of the Related Art

DE 196 48 539 C2 discloses a passive magnetic position sensor with a contact structure, the positioning of which can be changed by the action of a magnet device.

### SUMMARY OF THE INVENTION

An object of one aspect of the present invention is to provide a novel, preferably improved, angle detection device or angle detection arrangement, in particular to provide a fuel fill level detection device, and/or to improve production thereof, and/or function thereof.

One aspect of the invention is an angle detection device, an angle detection arrangement or fuel fill level detection device with an angle detection device described herein, or a method for the detection of an angle by an angle detection device, in particular angle detection arrangement, described herein, in particular for the detection of a fuel fill level by a fuel fill level detection device described herein or for the production of an angle detection device described herein.

According to one aspect of the present invention, an angle detection device has a support, a potting composition which in an embodiment is a liquid encapsulation system, in particular a glob top, this liquid encapsulation system or glob top being arranged in coherently bonded manner on the support, and a sensor that detects an orientation of a magnetic field of a magnet in contactless manner or is intended, in particular equipped or used, for that purpose.

In one aspect of the present invention, the sensor is a Hall effect sensor, in particular a 2D-vertical Hall sensor or 2D lateral Hall sensor, in particular a differential sensor or triaxial sensor, an xMR sensor, in particular an AMR sensor, GMR sensor or TMR sensor, a magnetic saturation sensor or the like.

In one aspect of the present invention, use of a sensor providing contactless detection can, in particular in comparison with the contact structure disclosed in DE 196 48 539 C2, reduce wear and thus improve reliability, precision, and/or lifetime.

According to one aspect of the present invention, the sensor is arranged partly or entirely or completely within the potting composition; in an embodiment thereof it is partly or entirely or completely overlaid or covered, or embedded into the potting composition.

In one aspect of the present invention, the sensor is arranged on the support. In one aspect of the present invention the sensor is arranged in coherently bonded manner, and in a further development it is arranged by soldering and/or chip-on-board technology (COB).

It is thus advantageously possible in an embodiment to protect the sensor from environmental effects. Use of the potting composition in an embodiment isolates the sensor by impermeable encapsulation, which in an embodiment is impermeable to air and/or to liquid, in particular impermeable to water, gasoline, and/or diesel, thus permitting (more) advantageous protection of the sensor from environmental effects.

In particular for this purpose, the potting composition is resistant in an embodiment to fuel, in particular to gasoline and/or to diesel.

In one aspect of the present invention, an external edge of the potting composition is arranged at a distance of at least 1 mm and at most 15 mm, in particular at most 10 mm, from an external edge of the support.

In one aspect of the present invention, it is thus advantageously possible to realize commercially advantageous manufacturing procedures in which a plurality of sensors and potting compositions are first applied to a (full-sized) support plate and then the sheet is divided to give supports for the individual angle sensors.

According to one aspect of the present invention, the angle detection device has one or more, preferably two or three conductor tracks, which in an embodiment are flat or planar, and which respectively in an embodiment are arranged in coherently bonded, flat manner, in particular on or in the support, and in an embodiment are intended, in particular equipped, or are used, for the transmission of electrical signals or as electrical conductor tracks. The support can therefore in particular comprise a substrate, in particular can be a substrate, in particular on or in which the conductor track(s) is/are arranged flat; in an embodiment it can be configured, together with the conductor track(s), as circuit support or circuit board.

By using supports with flat/planar conductor tracks in an embodiment, angle detection devices can be configured to be compact and/or can be produced easily; in particular, their sensors can be protected from environmental effects or in particular sealed to prevent ingress of fuel or the like, in particular when comparison is made with projecting metal pins, the frames, metal sheets, or the like.

In one aspect of the present invention, the sensor is arranged, in particular in coherently bonded manner, at least partly on the, or one or more of the, conductor track(s), or, in an embodiment, covers these (respectively) at least partly. It is thus possible, in an embodiment, to improve the, in particular coherently bonded, fixing of said sensor.

In an embodiment, the, or one or more of the, conductor track(s) extend(s) beyond the potting composition, and in an embodiment here the potting composition at least locally overlays the conductor track(s).

It is thus possible in one aspect of the present invention to achieve improvements of the integrity and/or production of the angle detection device, and to avoid passages within the internal space which pass through the support and impair the (durable) impermeability of the internal space and/or require (more) complicated methods of production and/or sealing.

In addition or alternatively, the, or one or more of the, conductor track(s respectively) is/are arranged entirely or completely or only partly within the potting composition, in particular being overlaid or covered by same or embedded into same, and/or connected to an electrical conductor structure, in an embodiment a through-contact structure (“DuKo”), which passes entirely or completely or (only) partly through the support, and which in an embodiment is connected to another conductor track which, in an embodiment, is arranged, in particular in coherently bonded manner, on a surface of the support, said surface facing away from the potting composition.

In one aspect of the present invention, the, or one or more of the, conductor structure(s) or through-contact structure(s respectively) comprise(s) a through-passage in the support which passes through said support, where the through-passage is filled in an electrically conductive manner or its (internal) wall is coated in electrically conductive manner so that, in an embodiment, starting from a side of the support, said side facing away from the potting composition, by way of the conductor structure or through-contact structure, electricity can be supplied to and/or tapped off from the conductor track that is connected to said through-passage and that is at least partly arranged within the potting composition.

In one aspect of the present invention, the, or one or more of the, conductor structure(s) or through-contact structure(s respectively) is/are closed or sealed so as to be impermeable to air and/or to liquid, in particular to water, gasoline, and/or diesel, in an embodiment being sealed in coherently bonded manner, in particular by soldering, in an embodiment by metallic or glass soldering or adhesive bonding, and/or by the potting composition.

In one aspect of the present invention, an end of the, or one or more of the, conductor structure(s respectively) is arranged in the potting composition. In an embodiment, both ends of the, or one or more of the, conductor structure(s respectively) are arranged outside of the potting composition.

It is thus possible in an embodiment respectively, in particular in combination of two or more of these features, to realize the signal transmission from the potting composition in a simple(r), (more) compact and/or (more) reliable manner.

In one aspect of the present invention, therefore, the, or one or more of the, conductor track(s) arranged entirely or completely within the potting composition is/are (respectively) connected to one (of the) conductor structure(s) whose one end is likewise arranged within the potting composition, in particular to said end, and in an embodiment the other end of said conductor structure can be connected to another conductor track on a surface of the support, said surface facing away from the potting composition.

Additionally or alternatively, in one aspect of the present invention, the, or one or more of the, conductor track(s) extending beyond the potting composition is/are (respectively) connected to one (of the) conductor structure(s) whose two ends are arranged outside of the potting composition, in particular to one of said ends, and in an embodiment the other end of said conductor structure can be connected to another conductor track on a surface of the support, the surface facing away from the potting composition.

In one aspect of the present invention, the, or one or more of the, conductor track(s), i.e. in particular the, or one or more of the, conductor track(s) extending beyond the potting composition, or the, or one or more of the, conductor track(s) in particular arranged entirely within the potting composition, connected to one (of the) electrical conductor structure(s) that passes through the support, is/are (respectively), in an embodiment, connected by way of at least one other conductor track to an (electrical) connection which is arranged, in an embodiment, on a side of the support, said side facing toward the potting composition or, in another embodiment, on a side of the support, said side facing away from the potting composition. In an embodiment, there can be a line fixed on the connection, in an embodiment in coherently bonded manner, in particular by soldering, or in frictionally bonded manner, in particular by a clamp.

In one aspect of the present invention, the angle detection device can be configured compactly via a connection on the potting-composition side, and in an embodiment the surface of the support, the surface facing away from the potting composition, can be better, or concomitantly, utilized via a connection facing away from the potting composition.

In one aspect of the present invention, the angle detection device comprises an evaluation circuit arranged entirely or partly within the potting composition, in particular, in an embodiment in coherently bonded manner, on the support, in an embodiment by chip-on-board technology (COB), and/or evaluates, in particular processes, signals from the sensor, or is intended, in particular equipped or used, for that purpose.

It is thus possible, in one aspect of the present invention, to realize the evaluation or processing of signals from the sensor at least partly via the angle detection device itself, and thus, to improve the connectability and/or the usefulness of the angle detection device.

In a further aspect of the present invention, the evaluation circuit is programmed by way of the or one or more of the conductor track(s), or evaluation circuit and optionally conductor track(s) are intended, in particular equipped, for that purpose, or are used for that purpose. In particular, a characteristic curve, which in an embodiment is variable, can be stored for the sensor in the evaluation circuit and/or can be prescribed, in particular varied, by way of the, or one or more of the, conductor track(s).

It is thus advantageously possible, in one aspect of the present invention, to carry out (initial or subsequent) adjustment of the angle detection device in situ.

In addition or alternatively, in one aspect of the present invention, the evaluation circuit is configured as bare chip (“bare die”).

It is thus possible, in one aspect of the present invention, to improve the production process and/or to configure the angle detection device compactly.

In addition or alternatively, in one aspect of the present invention, the evaluation circuit is configured with the sensor, or is combined with the sensor to give an integrated circuit.

It is thus possible, in one aspect of the present invention, to improve the production process and/or to configure the angle detection device compactly.

In one aspect of the present invention, the evaluation circuit is configured separately from the sensor, in particular evaluation circuit and sensor being arranged in an embodiment individually and/or at a distance from one another on the support.

It is thus possible, in one aspect of the present invention, to simplify the process of production of different angle detection devices.

In an embodiment, the angle detection device comprises one or more electrical components, in particular capacitor(s) or the like, these respectively being arranged entirely or partly within the potting composition, in an embodiment on the support and/or in coherently bonded manner, and are electrically connected to the sensor and/or the evaluation circuit, in particular by way of the, or one or more of the, conductor track(s).

It is thus possible, in one aspect of the present invention, advantageously to realize signal filtering and/or, in particular electrical, protection, in particular protection from interference voltages or from overload.

In one aspect of the present invention, the sensor, the evaluation circuit and/or the, or one or more of the, electrical component(s) are (respectively) connected to the, or one or more of the, conductor track(s), in an embodiment by contacts and/or lines, in particular bond wires or the like.

In one aspect of the present invention, electricity is supplied to, and/or tapped off from, the sensor, the evaluation circuit and/or the, or one or more of the, electrical component(s) by way of the, or one or more of the, conductor track(s), and/or signals, in particular electrical signals, are transmitted from the sensor, the evaluation circuit and/or the, or one or more of the, electrical component(s), and/or signals, in particular electrical signals, are transmitted to the sensor, the evaluation circuit and/or the, or one or more of the, electrical component(s) by way of the, or one or more of the, conductor track(s), or the conductor track(s) is/are used for that purpose, or this/these conductor track(s) is/are intended, in particular equipped, for that purpose.

It is thus possible, in one aspect of the present invention, to improve the production process and/or ease of electrical connection.

In one aspect of the present invention, the support comprises one or more electrically insulating surface regions, and in a further development comprises a single- or multilayer main body or a single- or multilayer substrate made of electrically insulating material.

It is thus possible, in one aspect of the present invention, to realize the conductor tracks in an advantageous manner or to insulate these electrically from one another.

In one aspect of the present invention, the potting composition comprises silicone material, acrylate material, plastics material, in particular polyurethane material, and/or epoxy-resin material, in an embodiment single-, two-, or multicomponent and/or optically and/or thermally curing material, in particular polymer material; it can in particular consist thereof or be produced therefrom, i.e. in particular via optical and/or thermal hardening of the potting material after application of support or sensor, evaluation circuit and/or electrical component(s).

It is thus possible, in one aspect of the present invention, to seal sensor, evaluation circuit or electrical component(s) particularly advantageously, in particular in an easy and/or reliable manner, by encapsulation, or to protect same from environmental influences.

In one aspect of the present invention, the support, in particular a surface of the support, said surface facing toward the potting composition, is coated entirely or completely or partly with a covering. In addition or alternatively, the potting composition is, in an embodiment, entirely or completely or partly coated with a, in particular said, covering, i.e. in particular together with the support. In addition or alternatively, the, or one or more of the, conductor track(s) is/are, in an embodiment, (respectively) completely or partly (concomitantly) coated with a, in particular said, covering, i.e. in particular together with the support and, respectively, the potting composition. In an embodiment, a support-side edge of the potting composition or an edge (region) or transition (region) between support and potting composition is entirely or completely or partly coated with a, in particular said, covering.

In one aspect of the present invention, the covering is fuel-resistant, in particular gasoline and/or diesel-resistant; in an embodiment, the covering comprises, in particular for that purpose, parylene, and can in particular consist thereof. In addition or alternatively, the covering is, in an embodiment, applied by chemical vapor deposition (CVD).

It is thus possible, in one aspect of the present invention, to seal sensor, evaluation circuit or electrical component(s) particularly advantageously, in particular in an easy and/or reliable manner, by encapsulation, or to protect same from environmental influences.

According to one aspect of the present invention, an angle detection arrangement comprises an angle detection device described herein and a movable magnet, where, in an embodiment, an orientation of a magnetic field of said magnet is detected, or detectable, in contactless manner by the sensor.

In an embodiment, the support is arranged between the potting composition and magnet, or the magnet is arranged on that side of the support that faces away from the potting composition.

It is thus possible, in one aspect of the present invention, to achieve direct contact to conductor tracks extending beyond the potting composition.

In one aspect of the present invention, the potting composition is arranged between the support and magnet, or the magnet is arranged on that side of the potting composition that faces away from the support.

It is thus possible, in one aspect of the present invention, to realize a through-contact structure in a particularly advantageous manner through the support. In addition or alternatively, it is thus possible, in an embodiment, to realize a small(er) distance between the sensor and the magnet.

In one aspect of the present invention, the magnet is (mounted so as to be) rotatable around an axis of rotation that is in particular kinematic, and which intersects the potting composition, in particular virtually, and/or which includes an angle that is at most 45°, in particular at most 30°, in an embodiment at most 15° with a height axis of the support, said height axis from being in the direction of the, in particular minimal, wall thickness of the support, said axis of rotation therefore in particular being, at least in essence, perpendicular to the support or plane thereof.

It is thus possible, in one aspect of the present invention, to configure the angle detection arrangement (more) compactly, and/or to detect (more) precisely the orientation or angular position of the magnet.

An angle detection device or angle detection arrangement of one aspect of the invention can particularly advantageously be used or intended, in particular equipped, for the detection of a fuel fill level, in particular by virtue of advantageous impermeability and/or angle detection.

Accordingly, in one aspect of the present invention a fuel fill level detection device in particular for a motor vehicle, comprises, in an embodiment of a motor vehicle, an angle detection device described herein and a magnet whose magnetic field orientation is detected or detectable in contactless manner by the sensor of the angle detection device, or comprises an angle detection arrangement described herein.

In one aspect of the present invention, there is a float coupled to said magnet or to the magnet of said angle detection arrangement of the fuel fill level detection device, in an embodiment mechanically coupled, in particular by way of a rod or the like, and/or in a manner such that a fill level change leads to a rotation, in particular defined rotation, of the magnet around a, or the, axis of rotation, or to a corresponding change of an orientation of the magnetic field of said magnet, this change being detectable or detected by the sensor.

According to an embodiment of the present invention, for the detection of an angle by an angle detection device described herein, in particular angle detection arrangement, in an embodiment for the detection of a fuel fill level by a fuel fill level detection device described herein, an orientation of a magnetic field of a, or of the, magnet is detected in contactless manner by the sensor, and a corresponding signal, processed in an embodiment via the evaluation circuit and/or on the basis of a characteristic curve which is stored in the angle detection device, in particular in the evaluation circuit, and which in an embodiment is prescribed, in particular changed, by way of the, or one or more of the, conductor track(s), is output, in an embodiment by way of the, or one or more of the, conductor track(s).

According to an aspect of the present invention, for the production of an angle detection device described herein, the potting composition is arranged in coherently bonded manner on the support, in particular at least partly on the sensor and optionally on the evaluation circuit and/or on the electrical component(s), in an embodiment in the form of liquid or paste, and in an embodiment is hardened there, in particular optically and/or thermally.

In addition or alternatively, according to an aspect of the present invention for the production of a plurality of angle detection devices described herein, which in an embodiment are of identical design, a plurality of sensors, and in an embodiment additionally a plurality of evaluation circuits and/or electrical components, are applied to a support plate, which is in particular unitary, and then said support plate is divided to give supports for the individual angle sensors.

In one aspect of the present invention, once the sensors and optionally evaluation circuits and/or electrical components have been applied to the support plate, a plurality of (portions of) potting compositions which in an embodiment are of identical type are coherently bonded to the support plate, which in one embodiment is still unitary, in a manner such that respectively one of the sensors and optionally one of the evaluation circuits and/or one or more of the electrical components is/are arranged entirely or partly in one of said potting compositions, optionally the support plate to which said components have been applied is coated with the covering, and then the support plate to which said components have been applied, and which has optionally been coated, is divided or separated to give (supports for the) or of the individual angle detection device(s). In particular, the support plates can therefore be commercially advantageous, or the angle detection devices can be produced by commercially advantageous manufacturing procedures.

In one aspect of the present invention, the sensor, the evaluation circuit and/or the electrical component(s) of the, or one or more, angle detection device(s respectively) are electrically connected to the, or one or more of the, conductor track(s), in an embodiment in coherently bonded manner, by way of contact and/or by wires, in particular bond-wires, in an embodiment during or after application of the sensors, evaluation circuits or electrical components to the support plate and before the application of the potting composition(s).

In one aspect of the invention, the support, with the conductor track(s), is configured as a circuit board or as a circuit carrier, or the support plate is configured as a circuit-board cluster.

In addition or alternatively, according to one aspect of the invention, the support comprises ceramic material, glass material, plastics material, and/or epoxy-resin material, in particular ceramic laminate, glass laminate, plastics laminate, and/or epoxy-resin laminate, and/or corresponding composite material, in an embodiment plastics material and/or epoxy-resin material, in particular polyimide, polytetrafluoroethylene or hydrocarbon resin, in particular with glass fibers and/or ceramic, in particular ceramic filler, and can in particular be produced therefrom, in particular therefore from ceramic material, epoxy-glassfiber composite material, hydrocarbon resin with ceramic filler, polytetrafluoroethylene-composite material with ceramic or polyimide-composite material with glass fibers.

It is thus possible respectively, according to one aspect of the invention, in particular by combining two or more of the abovementioned features, to improve the production and/or impermeability, in particular lifetime, of the angle detection device or fuel fill level detection device, and/or to produce these more easily.

### BRIEF DESCRIPTION OF THE FIGURES

The invention will be explained below in detail with reference to depictions in figures. Other advantageous further developments of the invention can be found in the dependent claims and in the description of preferred embodiments hereinafter. In this connection, the figures, which are partly in diagrammatic form, show the following:

FIG. 1 is a fuel fill level detection device with an angle detection arrangement with an angle detection device;

FIG. 2 is a plan view of the angle detection arrangement;

FIG. 3 is a section of the angle detection arrangement along the line in FIG. 2;

FIG. 4 is an angle detection arrangement depicted as in FIG. 3; and

FIG. 5 is a plan view of a support plate during the production of the angle detection device.

### DETAILED DESCRIPTION OF THE PRESENTLY PREFERRED EMBODIMENTS

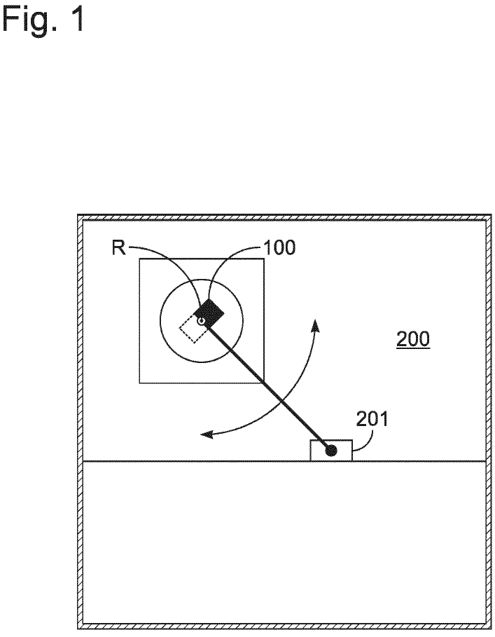

FIG. 1 shows a fuel fill level detection device arranged in a fuel tank 200 with an angle detection arrangement with an angle detection device according to an aspect of the present invention.

A float 201 is coupled to a permanent magnet 100 of the detection device in a manner such that a change of fill level leads to a rotation of the magnet 100 around an axis R of rotation, which is perpendicular to the plane of the join of FIG. 1.

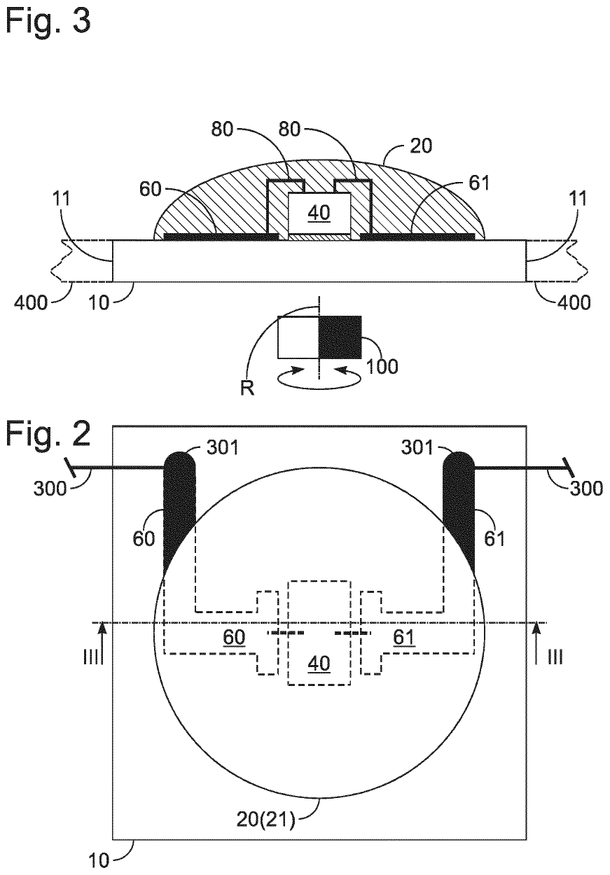

FIG. 2 shows a plan view of the angle detection arrangement. FIG. 3 shows the angle detection arrangement in a section along the line of FIG. 2.

The angle detection device of this angle detection arrangement has a support 10 and a potting composition in the form of a glob top 20.

Arranged in a coherently bonded manner on a surface, as shown in FIG. 3, an upper surface, of the support 10 there are two conductor tracks 60, 61, which are partly covered by the potting composition 20.

An external edge 21 of this potting composition 20 is at a distance of between 1 mm and 15 mm from an external edge 11 of the support 10.

Arranged within the potting composition 20 there is a sensor for the contactless detection of an orientation of a magnetic field of the magnet 100, this being combined in the implementation example of FIGS. 2, 3 with an evaluation circuit to give an integrated circuit 40, which is arranged in a coherently bonded manner on the support 10 and is connected by way of bond wires 80 to the conductor tracks 60, 61, which in turn extend beyond the potting composition 20 and by way of which firstly signals from the integrated circuit 40 can be output to lines 300 which, at connections 301, are connected in coherently or frictionally bonded manner to the conductor tracks 60, 61, and by way of which secondly, in the reverse direction, a characteristic curve of the evaluation circuit of the integrated circuit 40 is in-situ programmable, in particular reprogrammable, for the evaluation of the sensor.

In the implementation example of FIGS. 2, 3, the support 10 is arranged between the potting composition 20 and the magnet 100, the axis R of rotation of which passes through the potting composition 20 and includes an angle of about 0° with a height axis of the support in the direction of its wall thickness, which corresponds with the vertical in FIG. 3.

In order to detect the fill level, the orientation of the magnetic field of the magnet 100 is detected in contactless manner by the sensor of the integrated circuit 40, and a corresponding signal, processed via the evaluation circuit of the integrated circuit 40 on the basis of a characteristic curve programmed or stored therein, is output by way of the conductor tracks 60, 61 to the lines 300.

For the production of a plurality of the angle detection devices explained above of identical design, firstly a plurality of the integrated circuits 40 are applied to a support plate 400, indicated by broken lines in FIG. 3, arranged on the surface of which are the respective conductor tracks 60, 61, then the respective potting compositions 20 are arranged in coherently bonded manner with the support plate 400, and then the support plate 400 to which said components have thus been applied is divided to give supports 10 for the, or of the individual angle detection device(s).

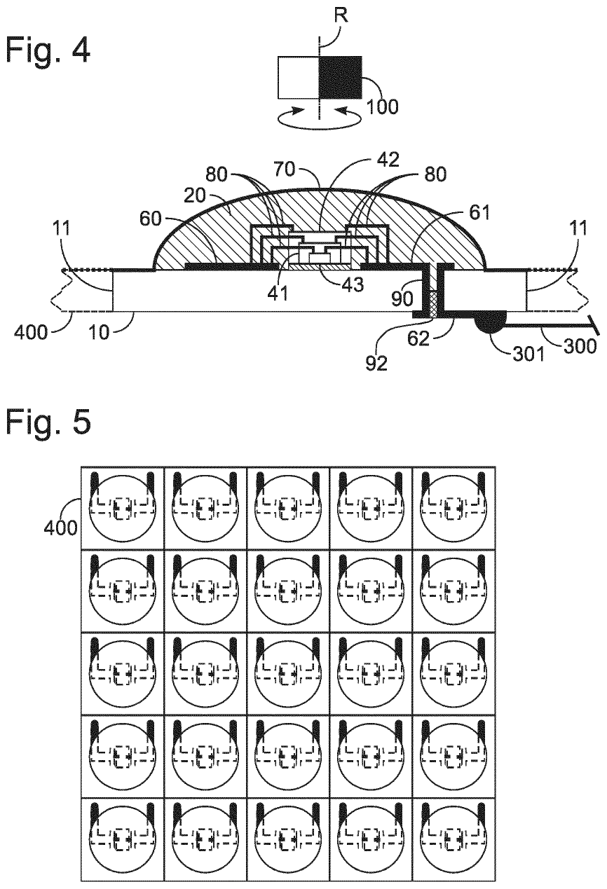

FIG. 4 shows, in a depiction corresponding to FIG. 3, an angle detection arrangement according to another embodiment of the present invention, which can be used instead of the angle detection arrangement of FIGS. 2, 3 for the fuel fill level detection device of FIG. 1.

Identical reference signs are used here to indicate features that are identical or have identical functions, and reference is therefore made to the description above, and details are provided below only in relation to differences.

In the implementation example of FIG. 4, the conductor tracks 60, 61 do not extend beyond the potting composition 20, but instead are connected to through-contacts 90, which pass through the support 10 and in turn are connected to conductor tracks 62, which are arranged on the surface of the support 10, said surface facing away from the potting composition (underneath in FIG. 4). The through-contacts 90 are sealed with a filler 92.

In the implementation example of FIG. 4, furthermore, the sensor 41 for the contactless detection of the orientation of the magnetic field of the magnet 100, the evaluation circuit in the form of a bare chip 42, and also a capacitor 43, are separately configured, respectively arranged in coherently bonded manner on the support 10, and connected by bond wires 80 to the conductor tracks 60, 61.

In the implementation of example of FIG. 4, the potting composition 20 is moreover arranged between support 10 and magnet 100 and coated with a fuel-resistant covering 70, where in particular the edge or transition region between support and potting composition is also coated with this covering 70.

FIG. 5 shows a plan view of the support plate 400 during the production of the angle detection device(s).

Although exemplary embodiments have been explained in the above description, it should be noted that numerous modifications are possible.

It is therefore also possible in particular to provide three or more conductor tracks instead of the two that are shown.

In addition, or alternatively, features explained with reference to the implementation example of FIG. 4 can also be realized in the implementation example of FIG. 2, 3 and vice versa, i.e. in particular the integrated circuit 40 and/or the arrangement of the magnet 100 in relation to the support side in the implementation example of FIG. 4, and/or the separate arrangement of sensor 41, evaluation circuit 42 and/or capacitor 43, the covering 70 and/or the arrangement of the magnet 100 in relation to the potting-composite side in the implementation example of FIG. 2, 3. In one embodiment here, the connections 301 and/or corresponding regions of the conductor tracks 60, 61 are free from any covering.

In addition or alternatively, the sensor 40 or 41 can be arranged, in an embodiment in coherently bonded manner, partly on the two conductor tracks 60, 61 or on one of these two conductor tracks 60, 61, or in an embodiment can (respectively) partly cover these.

It should be noted, furthermore, that the exemplary embodiments are merely examples which are in no way intended to limit the scope of protection, the applications, and the structure. Instead, the above description gives a person skilled in the art a guideline for the realization of at least one exemplary embodiment, and various changes can be made here, in particular with regard to the function and arrangement of the component parts described, without departing from the scope of protection resulting from the claims and feature combinations equivalent thereto.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. An angle detection device for a fuel fill level detection device, comprising:
a support;
a potting composition arranged on the support in coherently bonded manner;
a sensor arranged on the support and at least partially in the potting composition and configured for contactless detection of an orientation of a magnetic field of a magnet; and
at least one conductor track arranged flat on the support in a coherently bonded manner.

15. The angle detection device as claimed in claim 14, wherein an external edge of the potting composition is at a distance of at least 1 mm and at most 15 mm from an external edge of the support.

16. The angle detection device as claimed in claim 14, wherein the at least one conductor track extends beyond the potting composition.

17. The angle detection device as claimed in claim 14, wherein
the at least one conductor track is arranged entirely or partly within the potting composition and/or
is connected by an electrical conductor structure, configured as a through-contact structure, which passes at least partly through the support, and/or
comprising at least one further conductor track, to a connection arranged on a side of the support, the side facing toward the potting composition or facing away from the potting composition.

18. The angle detection device as claimed in claim 14, further comprising:
an evaluation circuit configured to evaluate of the sensor, which is programmable by way of the at least one conductor track and which is arranged at least partly within the potting composition, on the support, and configured as a bare chip and/or an integrated circuit with the sensor, or separately from the sensor.

19. The angle detection device as claimed in claim 14, further comprising at least one capacitor, which is arranged at least partly within the potting composition, on the support, and is electrically connected to the sensor and/or to an evaluation circuit, by way of the at least one conductor track.

20. The angle detection device as claimed in claim 14, wherein the support comprises:
at least one electrically insulating surface region and/or
ceramic material, glass material, plastics material and/or epoxy-resin material, and/or
the potting composition comprises silicone material, acrylate material, plastics material, and/or epoxy-resin material.

21. The angle detection device as claimed in claim 14, further comprising:
a covering that at least partly coats the support, the potting composition, and/or at least one conductor track.

22. The angle detection device as claimed in claim 21, wherein the covering comprises parylene and/or is applied by chemical vapor deposition.

23. An angle detection arrangement comprising:
an angle detection device, comprising:
a support;
a magnet;
a potting composition arranged on the support in coherently bonded manner;
a sensor arranged on the support and at least partially in the potting composition and configured for contactless detection of an orientation of a magnetic field of the magnet; and
at least one conductor track arranged flat on the support in a coherently bonded manner;
wherein
the support is arranged between the potting composition and the magnet or the potting composition is arranged between support and magnet, and/or
the magnet is mounted rotatably around an axis (R) of rotation which passes through the potting composition and/or
the support includes an angle of at most 45° with a height axis of the support in a direction of its wall thickness.

24. A fuel fill level detection device for a motor vehicle, comprising:
an angle detection device, comprising:
a support;
a magnet;
a potting composition arranged on the support in coherently bonded manner;
a sensor arranged on the support and at least partially in the potting composition and configured for contactless detection of an orientation of a magnetic field of the magnet;
at least one conductor track arranged flat on the support in a coherently bonded manner; and
a float coupled to the magnet,
wherein an orientation of a magnetic field of the magnet is detected in contactless manner by the sensor.

25. A method for the detection of an angle by an angle detection device, comprising:
an angle detection device, comprising:
a support;
a magnet;
a potting composition arranged on the support in coherently bonded manner;
a sensor arranged on the support and at least partially in the potting composition and configured for contactless detection of an orientation of a magnetic field of the magnet; and
at least one conductor track arranged flat on the support in a coherently bonded manner;
wherein
the support is arranged between the potting composition and the magnet or the potting composition is arranged between support and magnet, and/or
the magnet is mounted rotatably around an axis (R) of rotation which passes through the potting composition and/or
the support includes an angle of at most 45° with a height axis of the support in a direction of its wall thickness; and
detecting an orientation of a magnetic field of the magnet in a contactless manner by the sensor;
processing a corresponding signal via an evaluation circuit and/or on a basis of a characteristic curve stored in the angle detection device; and
outputting the processed signal output by way of the at least one conductor track.

26. A method for production of at least one angle detection device comprising:
a support;
a potting composition arranged on the support in coherently bonded manner;
a sensor arranged on the support and at least partially in the potting composition and configured for contactless detection of an orientation of a magnetic field of a magnet; and
at least one conductor track arranged flat on the support in a coherently bonded manner, the method comprising:
arranging the potting composition in a coherently bonded manner on the support, at least partly on the sensor, and/or
applying a plurality of sensors to a support plate and dividing the support plate to give supports for the at least one angle detection device.
